(19) United States
(12) Patent Application Publication
(10) Pub. No.: US 2025/0359647 A1
(43) Pub. Date: Nov. 27, 2025

(54) Hammock Mounting Bracket

(71) Applicant: Randall Lee Brown, Lorena, TX (US)

(72) Inventor: Randall Lee Brown, Lorena, TX (US)

(21) Appl. No.: 18/600,651

(22) Filed: Mar. 9, 2024

(51) Int. Cl. A45F 3/24; B60R 11/00

(52) U.S. Cl. CPC A45F 3/24; B60R 11/00; B60R 2011/0022; B60R 2011/0052

(57) ABSTRACT

Hammock mounting brackets are disclosed herein that may be used to mount different styles of hammocks inside the cabin of a vehicle. Once fastened to the frame of the vehicle will remain in place ready to be used to suspend gathered end style hammocks and bridge style hammocks within the cabin of a vehicle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

Traditionally, hammocks used for leisure activities, including sleeping are anchored between two supporting structures such as trees or posts. Portable hammock stands that suspend a hammock above the ground can be free-standing or attached to the trailer hitch of a vehicle can be used when trees or posts are not accessible. These portable hammock stands can be heavy, bulky, and are cumbersome to maneuver and assemble. These portable hammock stands expose the user to the elements.

Hammock mounting brackets have been developed, manufactured, and sold commercially that use the internal frame of a vehicle as attachment points for the hammock mounting bracket. Sold under the tradename Meraki Hammocks, these brackets suspend the hammock inside the cabin of the vehicle.

### FIELD OF THE INVENTION

This application generally relates to a hammock mounting bracket, and particularly a vehicle hammock mounting bracket for suspending a hammock inside the cabin of a vehicle.

### DESCRIPTION OF RELATED ART INCLUDING INFORMATION DISCLOSED UNDER 37 CFR 1.97 AND 1.98

Not Applicable

### BRIEF SUMMARY OF THE INVENTION

Hammock mounting brackets are disclosed herein that may be used to mount different styles of hammocks inside the cabin of a vehicle. These hammock mounting brackets are lightweight and once fastened to the frame of the vehicle will remain in place ready to be used to suspend hammocks within the cabin of the vehicle.

The hammock mounting brackets consist of apertures in which bolts are used to fasten the hammock mounting bracket to the frame where nut inserts are present. Where nut inserts are not present, the user may use blind nuts to secure the bolts through the hammock mounting bracket and to the frame.

The hammock mounting brackets allow for various hammock mounting solutions. The typical gathered end hammock makes use of carabiners at each end. When hammock mounting brackets are mounted diagonally on opposite sides of a vehicle, and each end of a hammock can be attached to an aperture in the hammock mounting brackets using carabiners.

Another method of gathering the end of hammocks is with a loop of cordage or webbing. Each bracket contains a U-shaped cut-out that creates a tab in which a loop of cordage or webbing can be secured. The user would insert one end of the loop of cordage or webbing into the aperture otherwise used for carabiners, and then around the tab created by the U-shaped cut-out. When pulled taught, the hammock is secured onto the hammock mounting bracket. This can be repeated that the other end of the hammock with a second hammock mounting bracket.

Another style of hammock that can be suspended inside of a vehicle using the hammock mounting brackets is a bridge style hammock. Bridge style hammocks are not gathered at the ends, but rather spread apart. By using a tension strap that is threaded through the slot of the hammock mounting brackets and then secured using a cam buckle, the webbed strap can be pulled taught. By securing tension straps at both ends of the cabin, two hammocks can be suspended side by side within the cabin of a vehicle.

### BRIEF DESCRIPTION OF THE SEVERAL VIEWS OF THE DRAWING(S)

FIG. 1 is a plan view of a hammock mounting bracket for suspending a hammock inside of a vehicle;

FIG. 1a is a left side perspective view thereof;

FIG. 1b is a right side perspective view thereof; and

FIG. 1c is a top side perspective view.

### DETAILED DESCRIPTION OF THE INVENTION

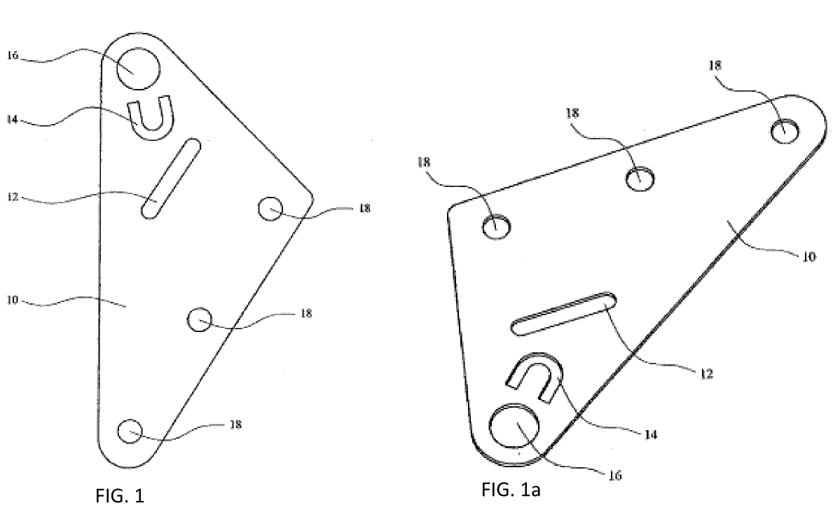

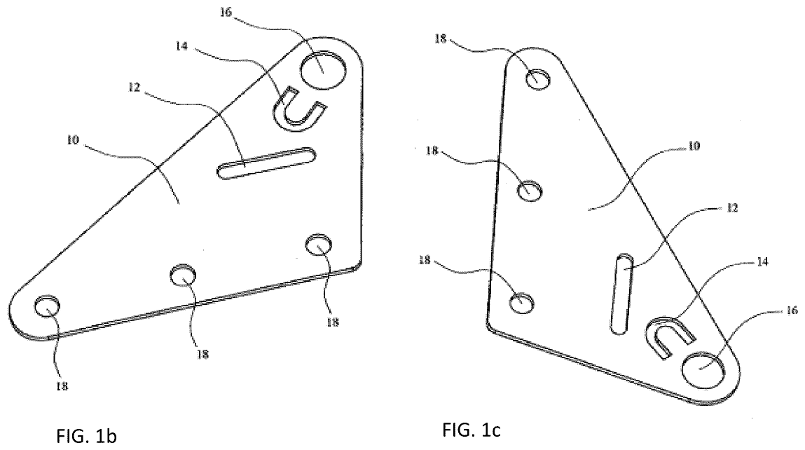

Referring to FIG. 1, a plan view of a hammock mounting bracket 10 is shown. The hammock mounting bracket 10 includes three apertures 18 on the right side that are configured to fasten the hammock mounting bracket 10 to the interior frame of a vehicle.

Referring to FIG. 1a, the hammock mounting bracket 10 shows an aperture 16 that is used to receive a carabiner.

Referring to FIG. 1b, the hammock mounting bracket 10 shows a tab 14 that is used to accept cordage or webbing that would be inserted through the aperture 16 and then looped over the tab 14. Referring to FIG. 1c, the hammock mounting bracket 10 shows a slot 12 that is used to accept webbing.

1. A hammock mounting bracket that can be configured to be mounted onto either the left or right b-pillar of a vehicle, and on top of the frame above the driver side window or above the passenger side window by orienting the bracket so that it may be fasted to the frame.

2. The system of claim 1 where in the mounting brackets can be fastened to the frame above the driver side window or the frame above the passenger side window using a bolt, washer and blind nuts.

3. The system of claim 1 where in the mounting brackets can be fastened to the b-pillar on either the driver side or to the b-pillar on the passenger side using bolts.

4. When one hammock mounting bracket is fastened to either the left and right b-pillar of a vehicle, and one hammock mounting bracket is fastened to the frame above either the driver side window or above the passenger side window, a hammock can be attached diagonally across the inside of a vehicle's cabin using a carabiner, cordage, or webbing.

5. When two hammock mounting brackets are fastened to the left and right b-pillar of a vehicle, and two hammock mounting brackets are fastened to the frame above the driver side window and above the passenger side window two bridge style hammocks can be suspended side by side within the cabin of the vehicle using a tension strap at each end of the hammocks and secured through the slots in the hammock mounting brackets.
